(19) United States
(12) Patent Application Publication
(10) Pub. No.: US 2024/0249209 A1
(43) Pub. Date: Jul. 25, 2024

(54) LEARNING DEVICE, PREDICTION DEVICE, PREDICTION SYSTEM, LEARNING METHOD, AND PREDICTION METHOD

(71) Applicant: Mitsubishi Electric Corporation, Tokyo (JP)

(72) Inventor: Jikang LIU, Tokyo (JP)

(73) Assignee: Mitsubishi Electric Corporation, Tokyo (JP)

(21) Appl. No.: 18/628,202

(22) Filed: Apr. 5, 2024

Related U.S. Application Data
(63) Continuation of application No. PCT/JP2021/038771, filed on Oct. 20, 2021.

(51) Int. Cl. G06Q 10/04; G06Q 50/40

(52) U.S. Cl. CPC G06Q 10/04; G06Q 50/40

(57) ABSTRACT

A learning device includes an acquisition unit that acquires first learning data as information indicating at least one of weather at a first spot at a plurality of times and congestion information as information regarding congestion, a normal prediction learned model that outputs a number of people in normal times at the first spot at a certain time when first information indicating at least one of the congestion information and the weather at the first spot at the certain time is inputted thereto, and true value information including true values indicating the numbers of people in normal times and in emergency times at the first spot at a plurality of times, a learning generation unit that generates an emergency prediction learned model that outputs the number of people in emergency times at the first spot at the certain time when the first information is inputted thereto by using the first learning data, the normal prediction learned model and the true value information, and an output unit that outputs the normal prediction learned model and the emergency prediction learned model.

### CROSS-REFERENCE TO RELATED APPLICATION

This application is a continuation application of International Application No. PCT/JP2021/038771 having an international filing date of Oct. 20, 2021.

### BACKGROUND OF THE INVENTION

### 1. Field of the Invention

The present disclosure relates to a learning device, a prediction device, a prediction system, a learning method, and a prediction method.

### 2. Description of the Related Art

There has been known a method of making a prediction by using a learned model. For example, Patent Reference 1 proposes a learning method for a model that makes a prediction.

Patent Reference 1: Japanese Patent Application Publication No. 2019-125048

Incidentally, learning data is necessary for generating a learned model. When it is desired to generate a learned model for making a prediction in normal times, data in normal times are prepared as the learning data. By using the learning data, the learned model for making the prediction in normal times is generated.

There is a case where a prediction needs to be made even in a time of emergency. In such the case, data in emergency times are also prepared as the learning data. When a large amount of data in emergency times have been prepared, prediction accuracy in normal times with the generated learned model is low. On the other hand, when a small amount of data in emergency times have been prepared, the prediction accuracy in emergency times with the generated learned model is low. As above, how to make high-accuracy predictions in normal times and in emergency times is an important issue.

### SUMMARY OF THE INVENTION

An object of the present disclosure is to make it possible to make high-accuracy predictions in normal times and in emergency times.

A learning device according to an aspect of the present disclosure is provided. The learning device includes an acquisition unit that acquires first learning data as information indicating at least one of weather at a first spot at a plurality of times and congestion information as information regarding congestion, a normal prediction learned model that outputs a number of people in normal times at the first spot at a certain time when first information indicating at least one of the congestion information and the weather at the first spot at the certain time is inputted thereto, and true value information including true values indicating the numbers of people in normal times at the first spot at a plurality of times and true values indicating the numbers of people in emergency times at the first spot at a plurality of times, a learning generation unit that generates an emergency prediction learned model that outputs the number of people in emergency times at the first spot at the certain time when the first information is inputted thereto by using the first learning data, the normal prediction learned model and the true value information, and an output unit that outputs the normal prediction learned model and the emergency prediction learned model.

According to the present disclosure, high-accuracy predictions in normal times and in emergency times can be made.

### BRIEF DESCRIPTION OF THE DRAWINGS

The present disclosure will become more fully understood from the detailed description given hereinbelow and the accompanying drawings which are given by way of illustration only, and thus are not limitative of the present disclosure, and wherein:

FIG. 1 is a diagram showing hardware included in a learning device in a first embodiment;

FIG. 2 is a block diagram showing functions of the learning device in the first embodiment;

FIG. 3 is a diagram (No. 1) for explaining a generation of an emergency prediction learned model in the first embodiment;

FIG. 4 is a diagram (No. 1) showing an example of a new learning data generation method in the first embodiment;

FIG. 5 is a diagram (No. 2) showing the example of the new learning data generation method in the first embodiment;

FIG. 6 is a diagram for explaining relearning in the first embodiment;

FIG. 7 is a diagram (No. 2) for explaining the generation of the emergency prediction learned model in the first embodiment;

FIG. 8 is a diagram showing a prediction system in the first embodiment;

FIG. 9 is a block diagram showing functions of a prediction device in the first embodiment;

FIG. 10 is a block diagram showing functions of a prediction device in a second embodiment; and

FIG. 11 is a diagram showing a concrete example of the second embodiment.

### DETAILED DESCRIPTION OF THE INVENTION

Embodiments will be described below with reference to the drawings. The following embodiments are just examples and a variety of modifications are possible within the scope of the present disclosure.

### First Embodiment

### <Learning Phase>

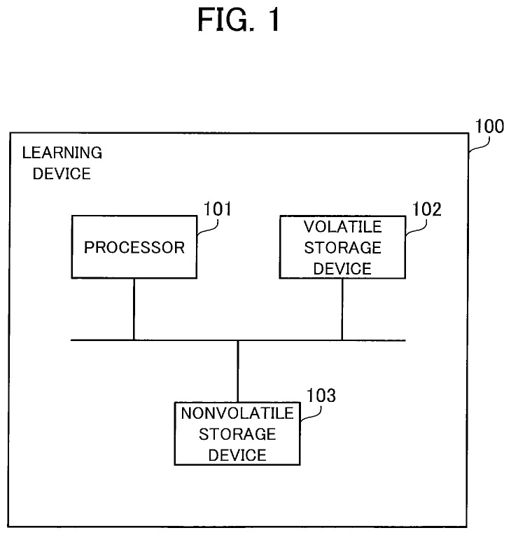

FIG. 1 is a diagram showing hardware included in a learning device in a first embodiment. The learning device 100 executes a learning method. The learning device 100 includes a processor 101, a volatile storage device 102 and a nonvolatile storage device 103.

The processor 101 controls the whole of the learning device 100. The processor 101 is a Central Processing Unit (CPU), a Field Programmable Gate Array (FPGA) or the like, for example. The processor 101 can also be a multiprocessor. Further, the learning device 100 may include a processing circuitry.

The volatile storage device 102 is main storage of the learning device 100. The volatile storage device 102 is a RAM (Random Access Memory), for example. The nonvolatile storage device 103 is auxiliary storage of the learning device 100. The nonvolatile storage device 103 is an HDD (Hard Disk Drive) or an SSD (Solid State Drive), for example.

Next, functions of the learning device 100 will be described below.

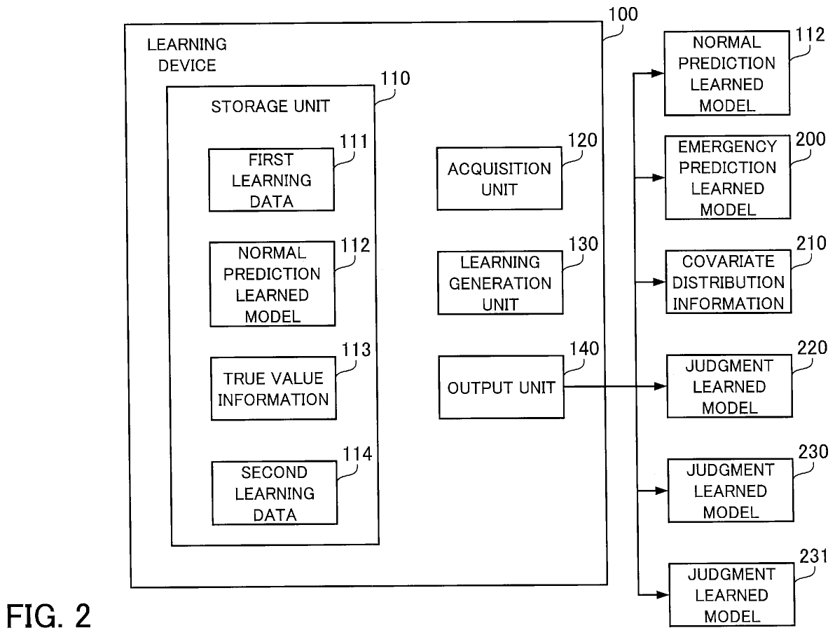

FIG. 2 is a block diagram showing the functions of the learning device in the first embodiment. The learning device 100 includes a storage unit 110, an acquisition unit 120, a learning generation unit 130 and an output unit 140.

The storage unit 110 may be implemented as a storage area reserved in the volatile storage device 102 or the nonvolatile storage device 103.

Part or all of the acquisition unit 120, the learning generation unit 130 and the output unit 140 may be implemented by the processing circuitry. Further, part or all of the acquisition unit 120, the learning generation unit 130 and the output unit 140 may be implemented as modules of a program executed by the processor 101. For example, the program executed by the processor 101 is referred to also as a learning program. The learning program has been recorded in a record medium, for example.

The storage unit 110 may store first learning data 111, a normal prediction learned model 112, true value information 113 and second learning data 114.

The first learning data 111 is information indicating at least one of weather at a first spot at a plurality of times and congestion information as information regarding congestion. For example, the first spot is a certain station. The weather is fine weather, cloudy weather, rain, typhoon, torrential rain, or the like. Incidentally, fine weather, cloudy weather and rain are normal weather. Typhoon and torrential rain are emergency weather. The congestion information is information indicating whether or not an event is ongoing at the first spot or in the vicinity of the first spot. The congestion information when no event is ongoing represents normality. The congestion information when an event is ongoing represents emergency. Incidentally, in cases where the first spot is a station, for example, the event is an event held in the station or an event held in the vicinity of the station (e.g., soccer or baseball). Further, in cases where the first spot is a station, the first learning data 111 can include operation schedule information (i.e., train schedule) on trains traveling through the station and operation information on the trains traveling through the station. Incidentally, the operation information on the trains is information indicating whether an accident (e.g., derailment accident) has occurred or not, for example. Then, the operation information when no accident has occurred represents normality. The operation information when an accident has occurred represents emergency. Furthermore, the first learning data 111 may also be generated by a user.

When information indicating at least one of the congestion information and the weather at the first spot at a certain time (referred to also as first information, for example) is inputted thereto, the normal prediction learned model 112 outputs the number of people in normal times at the first spot at the certain time. Further, in cases where the first spot is a station, when information indicating at least one of the congestion information and the weather at the first spot at a certain time and information indicating at least one of the operation schedule information on the trains and the operation information on the trains are inputted thereto, the normal prediction learned model 112 outputs the number of people in normal times at the first spot at the certain time.

The true value information 113 includes true values indicating the numbers of people in normal times at the first spot at a plurality of times and true values indicating the numbers of people in emergency times at the first spot at a plurality of times. Incidentally, the true values may be referred to also as learning true values.

The second learning data 114 is information indicating at least one of the congestion information and the weather at a spot other than the first spot at a plurality of times. For example, in cases where the first spot is Yokohama, the spot other than the first spot can be Osaka, Nagoya or the like. In cases where the spot other than the first spot is a station, the second learning data 114 can include the operation information on trains traveling through the station.

The acquisition unit 120 acquires the first learning data 111, the normal prediction learned model 112, the true value information 113 and the second learning data 114. For example, the acquisition unit 120 acquires the first learning data 111, the normal prediction learned model 112, the true value information 113 and the second learning data 114 from the storage unit 110. Alternatively, for example, the acquisition unit 120 acquires the first learning data 111, the normal prediction learned model 112, the true value information 113 and the second learning data 114 from an external device.

The learning generation unit 130 generates an emergency prediction learned model 200 by using the first learning data 111, the normal prediction learned model 112 and the true value information 113. When information indicating at least one of the congestion information and the weather at the first spot at a certain time is inputted thereto, the emergency prediction learned model 200 outputs the number of people in emergency times at the first spot at the certain time. Further, in cases where the first spot is a station, when information indicating at least one of the congestion information and the weather at the first spot at a certain time and information indicating at least one of the operation schedule information on the trains and the operation information on the trains are inputted thereto, the emergency prediction learned model 200 outputs the number of people in emergency times at the first spot at the certain time.

Next, the generation of the emergency prediction learned model will be explained in detail below.

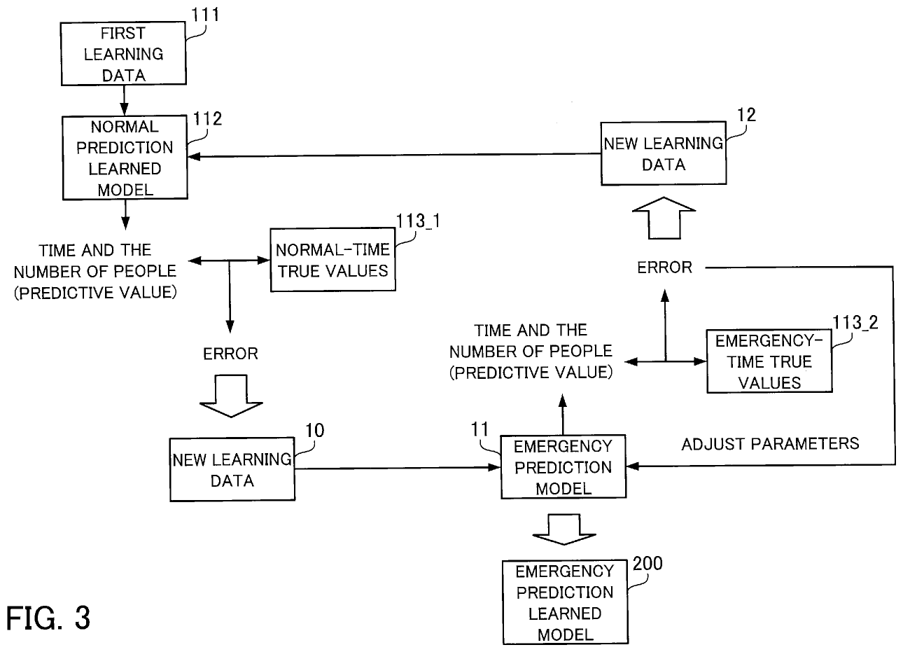

FIG. 3 is a diagram (No. 1) for explaining the generation of the emergency prediction learned model in the first embodiment. Referring to FIG. 3, a description will be given of a case where the emergency prediction learned model 200 is generated by means of learning. Gradient Boosting Decision Tree (GBDT), Long Short Term Memory (LSTM) or the like may be used in the learning.

The learning generation unit 130 inputs the first learning data 111 to the normal prediction learned model 112. Accordingly, the normal prediction learned model 112 outputs the number of people at the first spot at a certain time. For example, when the first learning data 111 is information indicating the weather at the first spot at 8 o'clock, the learning generation unit 130 inputs the information indicating the weather at the first spot at 8 o'clock to the normal prediction learned model 112. Accordingly, the normal prediction learned model 112 outputs the number of people at the first spot at 8 o'clock. Further, for example, when the first learning data 111 is the congestion information at the first spot at 9 o'clock and the congestion information indicates that an event is ongoing at the first spot, the learning generation unit 130 inputs the congestion information at the first spot at 9 o'clock to the normal prediction learned model 112. Accordingly, the normal prediction learned model 112 outputs the number of people at the first spot at 9 o'clock. Further, the normal prediction learned model 112 outputs a greater number of people since an event is ongoing at the first spot. Incidentally, the value outputted by the normal prediction learned model 112 is referred to also as a predictive value.

FIG. 3 shows normal-time true values 113_1. The normal-time true values 113_1 are true values included in the true value information 113 and indicating the numbers of people in normal times at the first spot at a plurality of times.

The learning generation unit 130 calculates an error by comparing the predictive value and the normal-time true value 113_1. For example, the learning generation unit 130 calculates the error by comparing the predictive value based on the information indicating the weather at the first spot at 8 o'clock and the true value indicating the number of people at the first spot at 8 o'clock included in the normal-time true values 113_1. As above, the learning generation unit 130 calculates the error by comparing the predictive value and the true value on the basis of the same time.

As above, the learning generation unit 130 calculates the numbers of people at the first spot at a plurality of times as a plurality of predictive values by using the first learning data 111 and the normal prediction learned model 112. Then, the learning generation unit 130 calculates a plurality of errors based on the normal-time true values 113_1 in the true value information 113 and the plurality of predictive values.

The learning generation unit 130 generates new learning data 10 based on the plurality of errors. The generation of the new learning data 10 will be described in detail below.

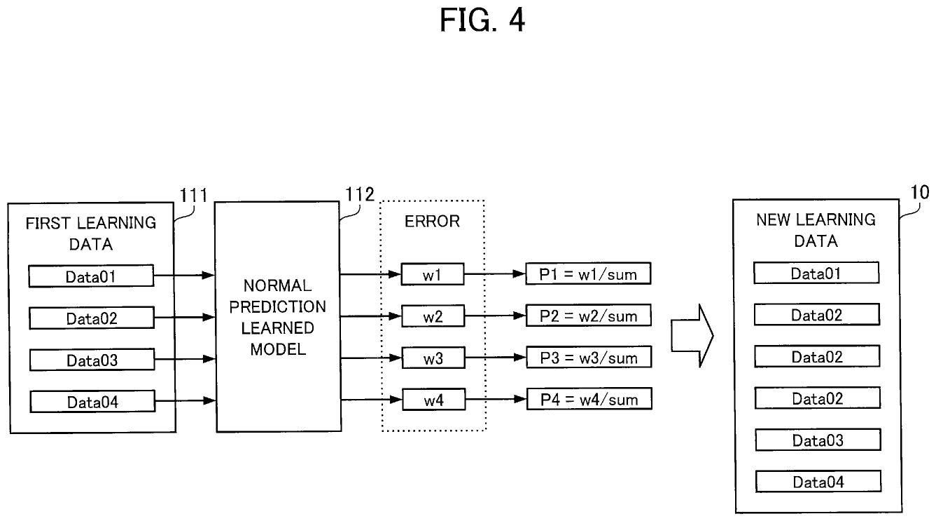

FIG. 4 is a diagram (No. 1) showing an example of a new learning data generation method in the first embodiment. FIG. 4 shows Data01 to Data04 as the first learning data 111. For example, Data01 is information indicating the weather at the first spot at 8 o'clock. For example, Data02 is information indicating the weather at the first spot at 8:30. For example, Data03 is information indicating the weather at the first spot at 9 o'clock. For example, Data04 is information indicating the weather at the first spot at 9:30.

As explained above, Data01 to Data04 are inputted to the normal prediction learned model 112. Accordingly, four predictive values are outputted. The learning generation unit 130 calculates errors w1 to w4 by comparing the four predictive values and the normal-time true values 113_1. The learning generation unit 130 calculates a proportion of each of the plurality of errors w1 to w4 in all the errors based on the errors w1 to w4. For example, the learning generation unit 130 calculates the proportion P1 of the error w1 by using expression (1).

$$P 1 = \frac{w 1}{sum ( w 1 + w 2 + w 3 + w 4 )} \qquad ( 1 )$$

The learning generation unit 130 increases the number of pieces of data included in the first learning data 111 depending on the proportion. Here, the increased data is data whose proportion is a great value. The data whose proportion is a great value is data whose error is great. The data whose error is great is data in emergency times. FIG. 4 indicates that the number of pieces of the data Data02 is increased. Thus, Data02 can be regarded as data in emergency times. Then, Data01, Data03 and Data04 can be regarded as data in normal times.

As above, the learning generation unit 130 increases the number of pieces of data in emergency times included in the first learning data 111 depending on the proportion. The learning generation unit 130 generates the first learning data 111, in which the number of pieces of data in emergency times has been increased, as the new learning data 10.

Further, the learning generation unit 130 generates a normal-time covariate distribution based on the data in normal times included in the first learning data 111.

Returning to FIG. 3, the explanation of the generation of the emergency prediction learned model is continued.

FIG. 3 indicates an emergency prediction model 11. Parameters as initial values have been set to the emergency prediction model 11.

The learning generation unit 130 inputs the new learning data 10 to the emergency prediction model 11. Here, by inputting the new learning data 10 to the emergency prediction model 11, the emergency prediction model 11 is learned by using a large number of pieces of data in emergency times.

The emergency prediction model 11 outputs the number of people in emergency times at the first spot at a certain time. Further, in cases where the first spot is a station, when information indicating at least one of the congestion information and the weather at the first spot at a certain time and information indicating at least one of the operation schedule information on the trains and the operation information on the trains are inputted thereto, the emergency prediction model 11 outputs the number of people in emergency times at the first spot at the certain time. Incidentally, the value outputted by the emergency prediction model 11 is referred to also as a predictive value.

FIG. 3 indicates emergency-time true values 113_2. The emergency-time true values 113_2 are true values included in the true value information 113 and indicating the numbers of people in emergency times at the first spot at a plurality of times.

The learning generation unit 130 calculates an error by comparing the predictive value and the emergency-time true value 113_2. For example, the learning generation unit 130 calculates the error by comparing the predictive value based on the information indicating the weather at the first spot at 9 o'clock and the true value indicating the number of people at the first spot at 9 o'clock included in the emergency-time true values 113_2. As above, the learning generation unit 130 calculates the error by comparing the predictive value and the true value on the basis of the same time. The learning generation unit 130 generates new learning data 12 based on the error. The generation of the new learning data 12 will be described in detail below.

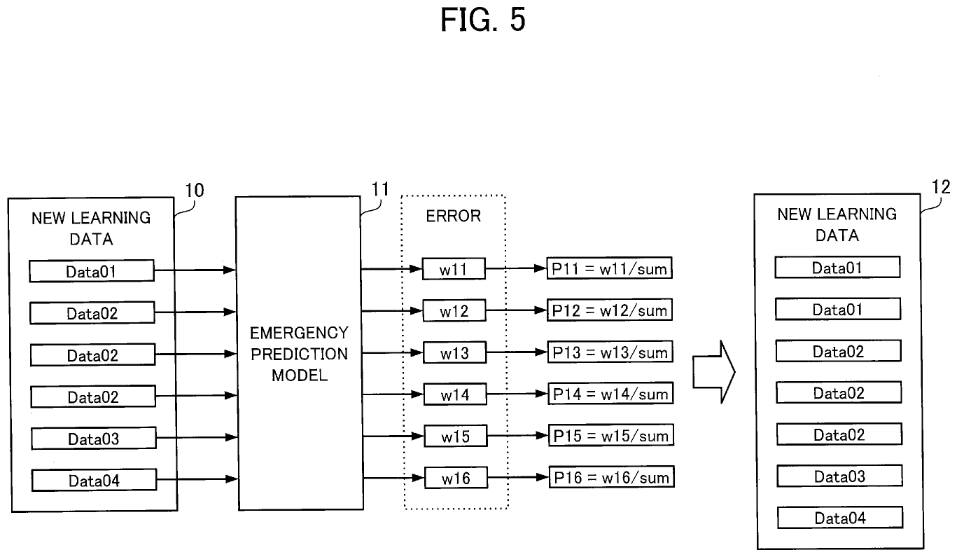

FIG. 5 is a diagram (No. 2) showing the example of the new learning data generation method in the first embodiment. FIG. 5 shows Data01 to Data04 as the new learning data 10. As explained earlier, the new learning data 10 is inputted to the emergency prediction model 11. Accordingly, six predictive values are outputted. The learning generation unit 130 calculates errors w11 to w16 by comparing the six predictive values and the emergency-time true values 113_2. The learning generation unit 130 calculates the proportion of each of the plurality of errors w11 to w16 in all the errors based on the errors w11 to w16.

The learning generation unit 130 increases the number of pieces of data included in the new learning data 10 depending on the proportion. The learning generation unit 130 generates the new learning data 12 by increasing the number of pieces of data included in the new learning data 10. Here, the new learning data 12 is referred to also as learning information including the first learning data 111.

Further, the learning generation unit 130 generates an emergency-time covariate distribution based on the data in emergency times included in the new learning data 10.

Returning to FIG. 3, the explanation of the generation of the emergency prediction learned model is continued.

If the error when the emergency prediction model 11 has been made to perform the learning by using data in emergency times is greater than a predetermined threshold value, the learning generation unit 130 adjusts the parameters in the emergency prediction model 11. That is, since the emergency prediction model 11 forms a neural network, the learning generation unit 130 adjusts the parameters as weights used in the neural network.

The learning generation unit 130 inputs the new learning data 12 to the normal prediction learned model 112. Then, the learning generation unit 130 generates the new learning data 10. The learning generation unit 130 inputs the generated new learning data 10 to the emergency prediction model 11. The learning generation unit 130 repeats the process of inputting learning data to the normal prediction learned model 112 and the emergency prediction model 11 until the error when the emergency prediction model 11 has been made to learn data in emergency times becomes less than or equal to the threshold value and the error converges. Then, when the error has converged, the emergency prediction learned model 200 is generated.

As above, the learning generation unit 130 generates the emergency prediction learned model 200 by using the emergency-time true values 113_2 in the true value information 113 and the new learning data 10.

It has been described above that the normal-time covariate distribution and the emergency-time covariate distribution are generated. Information including the normal-time covariate distribution and the emergency-time covariate distribution is referred to as covariate distribution information 210.

The above explanation of FIG. 3 has been given of the case where the emergency prediction model 11 is learned. The learning generation unit 130 may also make the normal prediction learned model 112 perform relearning. In short, the learning generation unit 130 makes the normal prediction learned model 112 perform the relearning while making the emergency prediction model 11 perform the learning. The relearning will be explained below.

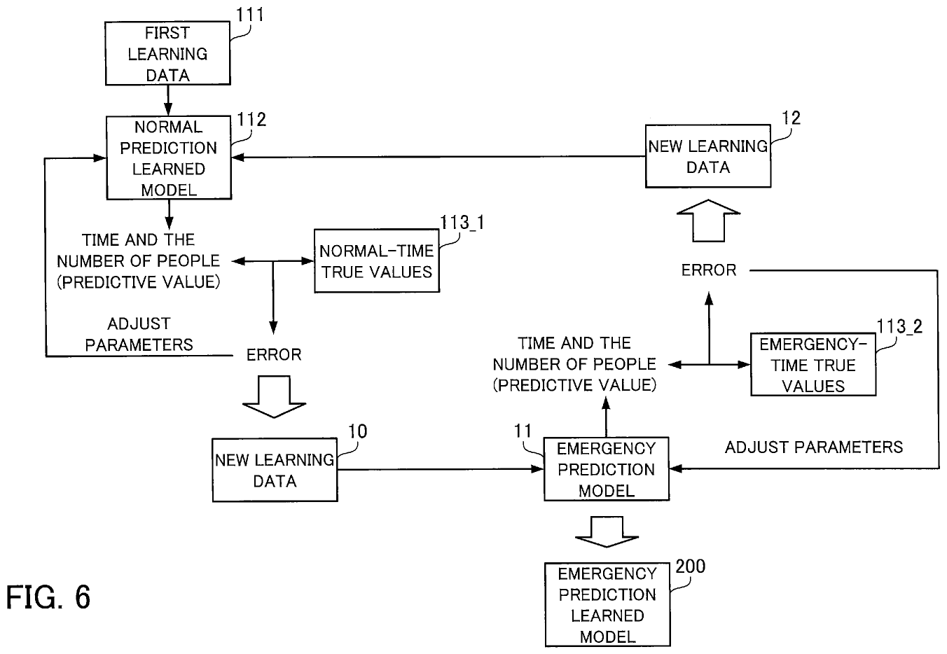

FIG. 6 is a diagram for explaining the relearning in the first embodiment. The learning generation unit 130 calculates the number of people at the first spot at a certain time as the predictive value by using the data in normal times included in the first learning data 111 or the new learning data 12 and the normal prediction learned model 112. The learning generation unit 130 calculates the error between the normal-time true value 113_1 and the predictive value. When the calculated error is included in a predetermined range, the learning generation unit 130 adjusts parameters in the normal prediction learned model 112. In short, since the normal prediction learned model 112 forms a neural network, the learning generation unit 130 adjusts the parameters as weights used in the neural network. Incidentally, the range is a range of small values.

As above, the learning generation unit 130 relearns the normal prediction learned model 112. By the relearning, the learning generation unit 130 is capable of reducing the error. In other words, the learning generation unit 130 is capable of increasing the prediction accuracy of the normal prediction learned model 112.

The above description with reference to FIGS. 3 and 6 has been given of the case where the process of inputting learning data to the normal prediction learned model 112 and the emergency prediction model 11 is repeated. A method different from that of FIGS. 3 and 6 will be described below.

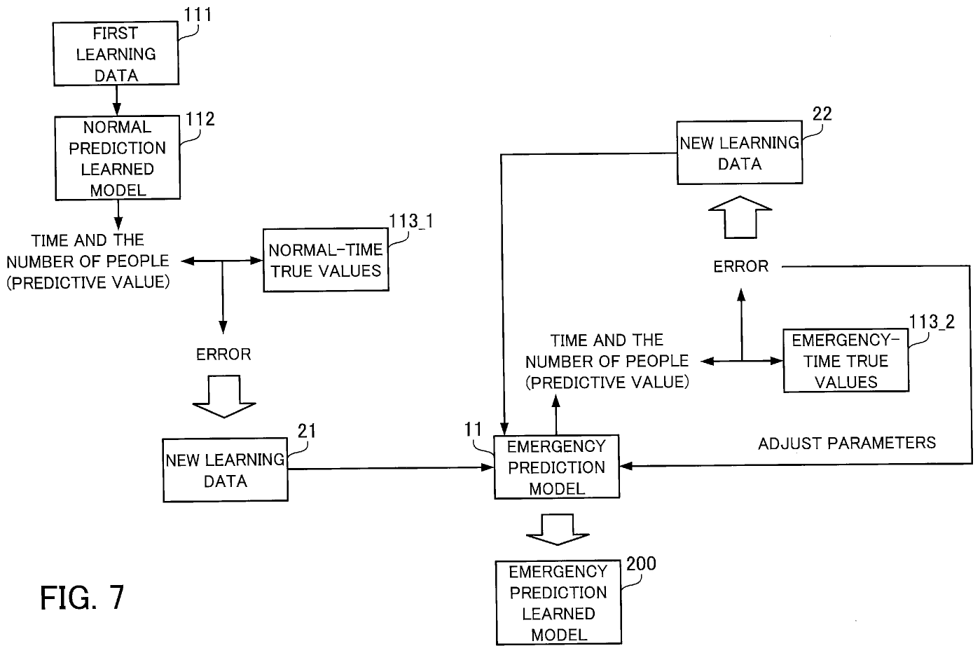

FIG. 7 is a diagram (No. 2) for explaining the generation of the emergency prediction learned model in the first embodiment.

The learning generation unit 130 inputs the first learning data 111 to the normal prediction learned model 112. Accordingly, the normal prediction learned model 112 outputs the number of people at the first spot at a certain time.

The learning generation unit 130 calculates the error by comparing the predictive value and the normal-time true value 113_1. The learning generation unit 130 identifies data included in the first learning data 111 and corresponding to an error greater than or equal to a predetermined threshold value. Here, the normal prediction learned model 112 has not learned data in emergency times, and thus the error becomes large when data in emergency times is inputted to the normal prediction learned model 112. Therefore, such data whose error between the predictive value and the normal-time true value 113_1 is greater than or equal to the threshold value can be regarded as data in emergency times. Thus, the identified data are data in emergency times. The learning generation unit 130 generates the identified data in emergency times as new learning data 21. Thus, all of the data included in the new learning data 21 are data in emergency times.

As above, the learning generation unit 130 identifies data in emergency times out of the first learning data 111 by using the first learning data 111, the normal prediction learned model 112, and the normal-time true values 113_1 in the true value information 113. Then, the learning generation unit 130 generates the identified data in emergency times as the new learning data 21.

The learning generation unit 130 identifies data in normal times out of the first learning data 111 based on the new learning data 21 (i.e., the data in emergency times). In short, the learning generation unit 130 identifies the data in normal times by excluding the new learning data 21 from the first learning data 111. The learning generation unit 130 generates the normal-time covariate distribution based on the data in normal times. The learning generation unit 130 generates the emergency-time covariate distribution based on the new learning data 21 (i.e., the data in emergency times).

The learning generation unit 130 inputs the new learning data 21 to the emergency prediction model 11. The emergency prediction model 11 outputs the number of people at the first spot at a certain time. Incidentally, the value outputted by the emergency prediction model 11 is referred to also as a predictive value.

The learning generation unit 130 calculates the error by comparing the predictive value and the emergency-time true value 113_2. The learning generation unit 130 generates data included in the new learning data 21 and corresponding to an error greater than or equal to a predetermined threshold value as new learning data 22. Here, such data corresponding to an error greater than or equal to the threshold value are data in emergency times in a case where the learning has not been performed adequately.

Further, if the error when the emergency prediction model 11 has been made to perform the learning by using data in emergency times is greater than or equal to the threshold value, the learning generation unit 130 adjusts the parameters in the emergency prediction model 11.

Since the parameters in the emergency prediction model 11 have been adjusted, the learning generation unit 130 inputs the new learning data 22 to the emergency prediction model 11 in order to confirm that the prediction accuracy of the emergency prediction model 11 has increased. The learning generation unit 130 repeats the process of inputting learning data to the emergency prediction model 11 until the error when the learning of data in emergency times has been performed by the emergency prediction model 11 becomes less than the threshold value and the error converges. Then, when the error has converged, the emergency prediction learned model 200 is generated.

As above, the learning generation unit 130 generates the emergency prediction learned model 200 by using the new learning data 21 and the emergency-time true values 113_2 in the true value information 113.

It has been described above that the normal-time covariate distribution and the emergency-time covariate distribution are generated. Information including the normal-time covariate distribution and the emergency-time covariate distribution is referred to as the covariate distribution information 210.

The learning methods of the emergency prediction model 11 in FIGS. 3, 6 and 7 have a characteristic in that the learning can be carried out without the need of putting a label indicating whether or not data is data in normal times or data in emergency times on the first learning data 111. Thus, by using the learning methods, the burden on a user for preparing the learning data can be lightened. Returning to FIG. 2, the functions of the learning generation unit 130 will be described further.

The learning generation unit 130 generates a judgment learned model 220 that outputs information indicating whether input information is data in normal times or data in emergency times when information indicating at least one of the congestion information and the weather at the first spot at a certain time is inputted thereto, by using the first learning data 111. For example, when information indicating that the weather at the first spot at 10 o'clock is fine weather is inputted thereto, the judgment learned model 220 outputs information indicating that the input information is data in normal times. Further, for example, when information indicating that the weather at the first spot at 11 o'clock is torrential rain is inputted thereto, the judgment learned model 220 outputs information indicating that the input information is data in emergency times. Here, the judgment learned model 220 is referred to also as a first judgment learned model.

It is also possible for the learning generation unit 130 to generate a judgment learned model 220 that outputs information indicating whether input information, including information indicating at least one of the congestion information and the weather at the first spot at a certain time and the operation information, is data in normal times or data in emergency times when the information indicating at least one of the congestion information and the weather at the first spot at a certain time and the operation information are inputted thereto, by using the first learning data 111.

Further, it is also possible for the learning generation unit 130 to generate a judgment learned model 220 that outputs a probability that input information is data in normal times and a probability that the input information is data in emergency times when information indicating at least one of the congestion information and the weather at the first spot at a certain time is inputted thereto, by using the first learning data 111.

Furthermore, it is also possible for the learning generation unit 130 to generate a judgment learned model 220 that outputs a probability that input information, including information indicating at least one of the congestion information and the weather at the first spot at a certain time and the operation information, is data in normal times and a probability that the input information is data in emergency times when the information indicating at least one of the congestion information and the weather at the first spot at a certain time and the operation information are inputted thereto, by using the first learning data 111.

The learning generation unit 130 generates each judgment learned model 230, 231 that outputs information indicating whether input information is data in normal times or data in emergency times when information indicating at least one of the congestion information and the weather at a spot other than the first spot at a certain time (referred to also as second information, for example) is inputted thereto, by using the second learning data 114. For example, the learning generation unit 130 generates the judgment learned model 230 that outputs information indicating whether input information is data in normal times or data in emergency times when information indicating at least one of the congestion information and the weather at Osaka at a certain time is inputted thereto, by using the second learning data 114. Further, for example, the learning generation unit 130 generates the judgment learned model 231 that outputs information indicating whether input information is data in normal times or data in emergency times when information indicating at least one of the congestion information and the weather at Nagoya at a certain time is inputted thereto, by using the second learning data 114. Here, each of the judgment learned models 230 and 231 is referred to also as a second judgment learned model.

Incidentally, the spot other than the first spot is desired to be a spot near to the first spot.

It is also possible for the learning generation unit 130 to generate each judgment learned model 230, 231 that outputs information indicating whether input information, including information indicating at least one of the congestion information and the weather at a spot other than the first spot at a certain time and the operation information, is data in normal times or data in emergency times when the information indicating at least one of the congestion information and the weather at a spot other than the first spot at a certain time and the operation information are inputted thereto, by using the second learning data 114.

Further, it is also possible for the learning generation unit 130 to generate each judgment learned model 230, 231 that outputs a probability that input information is data in normal times and a probability that the input information is data in emergency times when information indicating at least one of the congestion information and the weather at a spot other than the first spot at a certain time is inputted thereto, by using the second learning data 114.

Furthermore, it is also possible for the learning generation unit 130 to generate each judgment learned model 230, 231 that outputs a probability that input information, including information indicating at least one of the congestion information and the weather at a spot other than the first spot at a certain time and the operation information, is data in normal times and a probability that the input information is data in emergency times when the information indicating at least one of the congestion information and the weather at a spot other than the first spot at a certain time and the operation information are inputted thereto, by using the second learning data 114. Incidentally, the above description has been given of cases where two judgment learned models (i.e., the judgment learned models 230 and 231) are generated. The learning generation unit 130 may also be configured to generate one judgment learned model (e.g., the judgment learned model 230).

As shown in FIG. 2, the learning device 100 generates the emergency prediction learned model 200, the covariate distribution information 210, the judgment learned model 220, the judgment learned model 230 and the judgment learned model 231. Further, in cases where the normal prediction learned model 112 has been relearned, the learning device 100 generates the relearned normal prediction learned model 112.

The output unit 140 outputs information. For example, the output unit 140 outputs the information to the storage unit 110. For example, the output unit 140 outputs the information to an external device. Incidentally, the information is, for example, the normal prediction learned model 112, the emergency prediction learned model 200, the covariate distribution information 210, the judgment learned model 220, the judgment learned model 230 and the judgment learned model 231. The output unit 140 may output the relearned normal prediction learned model 112.

According to the learning phase, the learning device 100 prepares the normal prediction learned model 112 and the emergency prediction learned model 200. As will be described later, high-accuracy predictions in normal times and in emergency times can be made by using the normal prediction learned model 112 and the emergency prediction learned model 200. Thus, thanks to the preparation of the normal prediction learned model 112 and the emergency prediction learned model 200, high-accuracy predictions in normal times and in emergency times can be made.

Next, a utilization phase will be described below.

### <Utilization Phase>

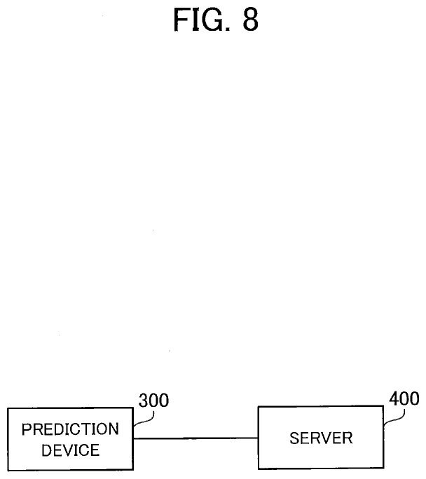

FIG. 8 is a diagram showing a prediction system in the first embodiment. The prediction system includes a prediction device 300 and a server 400. The prediction device 300 executes a prediction method. The prediction device 300 includes a processor, a volatile storage device and a nonvolatile storage device. Further, the prediction device 300 may include a processing circuitry. The server 400 is a cloud server, for example.

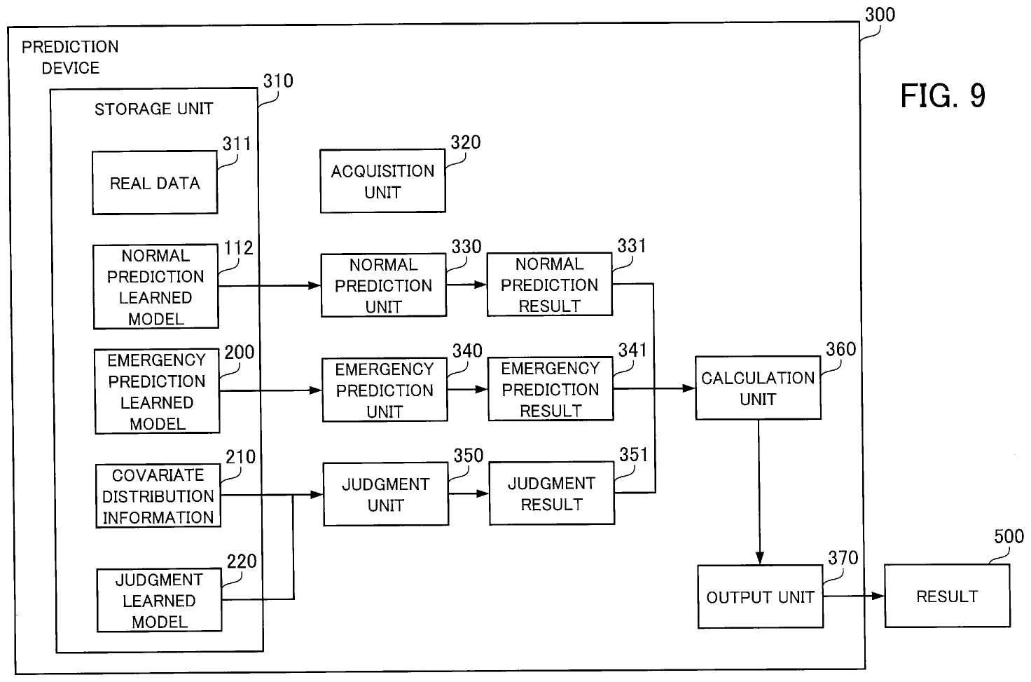

FIG. 9 is a block diagram showing functions of the prediction device in the first embodiment. The prediction device 300 includes a storage unit 310, an acquisition unit 320, a normal prediction unit 330, an emergency prediction unit 340, a judgment unit 350, a calculation unit 360 and an output unit 370.

The storage unit 310 may be implemented as a storage area reserved in the volatile storage device or the nonvolatile storage device included in the prediction device 300.

Part or all of the acquisition unit 320, the normal prediction unit 330, the emergency prediction unit 340, the judgment unit 350, the calculation unit 360 and the output unit 370 may be implemented by the processing circuitry included in the prediction device 300. Further, part or all of the acquisition unit 320, the normal prediction unit 330, the emergency prediction unit 340, the judgment unit 350, the calculation unit 360 and the output unit 370 may be implemented as modules of a program executed by the processor included in the prediction device 300. For example, the program is referred to also as a prediction program. The prediction program has been recorded in a record medium, for example.

The storage unit 310 may store real data 311, the normal prediction learned model 112, the emergency prediction learned model 200, the covariate distribution information 210 and the judgment learned model 220.

The real data 311 is information indicating at least one of the weather at the first spot at a certain time and the congestion information as information regarding congestion. Further, in cases where the first spot is a station, the real data 311 may include the operation schedule information (i.e., train schedule) on the trains traveling through the station and the operation information on the trains traveling through the station.

Here, the server 400 may store the real data 311, the normal prediction learned model 112, the emergency prediction learned model 200, the covariate distribution information 210 and the judgment learned model 220.

Incidentally, in cases where the normal prediction learned model 112 has been relearned by the learning device 100, the normal prediction learned model 112 stored in the storage unit 310 or the server 400 is the relearned learned model.

The acquisition unit 320 acquires the real data 311, the normal prediction learned model 112, the emergency prediction learned model 200, the covariate distribution information 210 and the judgment learned model 220. For example, the acquisition unit 320 acquires the real data 311, the normal prediction learned model 112, the emergency prediction learned model 200, the covariate distribution information 210 and the judgment learned model 220 from the storage unit 310. Alternatively, for example, the acquisition unit 320 acquires the real data 311, the normal prediction learned model 112, the emergency prediction learned model 200, the covariate distribution information 210 and the judgment learned model 220 from the server 400.

The normal prediction unit 330 predicts the number of people at the first spot at a time indicated by the real data 311 by using the real data 311 and the normal prediction learned model 112. The result of the prediction is referred to as a normal prediction result 331. That is, the normal prediction result 331 indicates the number of people in normal times.

The emergency prediction unit 340 predicts the number of people at the first spot at a time indicated by the real data 311 by using the real data 311 and the emergency prediction learned model 200. The result of the prediction is referred to as an emergency prediction result 341. That is, the emergency prediction result 341 indicates the number of people in emergency times.

The judgment unit 350 judges whether the real data 311 is data in normal times or data in emergency times by using the real data 311 and the judgment learned model 220. The result of the judgment is referred to as a judgment result 351.

It is also possible for the judgment unit 350 to judge whether the real data 311 is data in normal times or data in emergency times by using the real data 311, the covariate distribution information 210 and the judgment learned model 220. By use of the covariate distribution information 210, the judgment unit 350 is capable of making a high-accuracy judgment.

The calculation unit 360 calculates the number of people at the first spot at a time indicated by the real data 311 by using the normal prediction result 331, the emergency prediction result 341 and the judgment result 351. For example, when the judgment result 351 indicates that the real data 311 is data in normal times, the calculation unit 360 calculates the result indicated by the normal prediction result 331 as the number of people at the first spot at the time indicated by the real data 311. This calculation may be considered as follows. The calculation unit 360 calculates the number of people at the first spot at the time indicated by the real data 311 by multiplying the normal prediction result 331 by “1” and multiplying the emergency prediction result 341 by “0”. Further, for example, when the judgment result 351 indicates that the real data 311 is data in emergency times, the calculation unit 360 calculates the result indicated by the emergency prediction result 341 as the number of people at the first spot at the time indicated by the real data 311.

Here, as mentioned earlier, it is also possible for the judgment learned model 220 to output the probability that the input information is data in normal times and the probability that the input information is data in emergency times. In cases where the judgment learned model 220 is capable of outputting the two probabilities, the judgment unit 350 judges the probability that the real data 311 is data in normal times and the probability that the real data 311 is data in emergency times, by using the real data 311 and the judgment learned model 220. Then, the result of the judgment is referred to as the judgment result 351. It is also possible for the judgment unit 350 to judge the probability that the real data 311 is data in normal times and the probability that the real data 311 is data in emergency times, by using the real data 311, the covariate distribution information 210 and the judgment learned model 220.

In the cases where the judgment learned model 220 is capable of outputting the two probabilities, the calculation unit 360 calculates the number of people at the first spot at the time indicated by the real data 311 by using the normal prediction result 331, the emergency prediction result 341 and the judgment result 351. For example, the judgment result 351 is assumed to indicate that the probability “80%” of being data in normal times and the probability “20%” of being data in emergency times. The calculation unit 360 calculates the number of people at the first spot at the time indicated by the real data 311 by using a weighted average. Specifically, the calculation unit 360 calculates the number of people by using expression (2).

$$THE NUMBER OF PEOPLE = ( NORMAL PREDICTION RESULT ( THE NUMBER OF PEOPLE ) \times 0.8 + EMERGENCY PREDICTION RESULT ( THE NUMBER OF PEOPLE ) \times 0.2 ) / ( 0.8 + 0.2 ) \qquad ( 2 )$$

As above, the calculation unit 360 may calculate the number of people by using the expression (2).

The output unit 370 outputs the result 500 of the calculation. For example, the output unit 370 outputs the result 500 to a display connected to the prediction device 300. Alternatively, for example, the output unit 370 outputs the result 500 to a different device.

According to the utilization phase, the prediction device 300 makes high-accuracy predictions in normal times and in emergency times by using the normal prediction learned model 112 and the emergency prediction learned model 200. Thus, the prediction device 300 is capable of making high-accuracy predictions in normal times and in emergency times.

### Second Embodiment

Next, a second embodiment will be described below. In the second embodiment, the description will be given mainly of features different from those in the first embodiment. In the second embodiment, the description is omitted for features in common with the first embodiment.

In the first embodiment, a description was given of cases where the judgment learned model 220 is used. In the second embodiment, a description will be given of cases where the judgment learned models 230 and 231 are used. Here, the server 400 may store the judgment learned models 230 and 231.

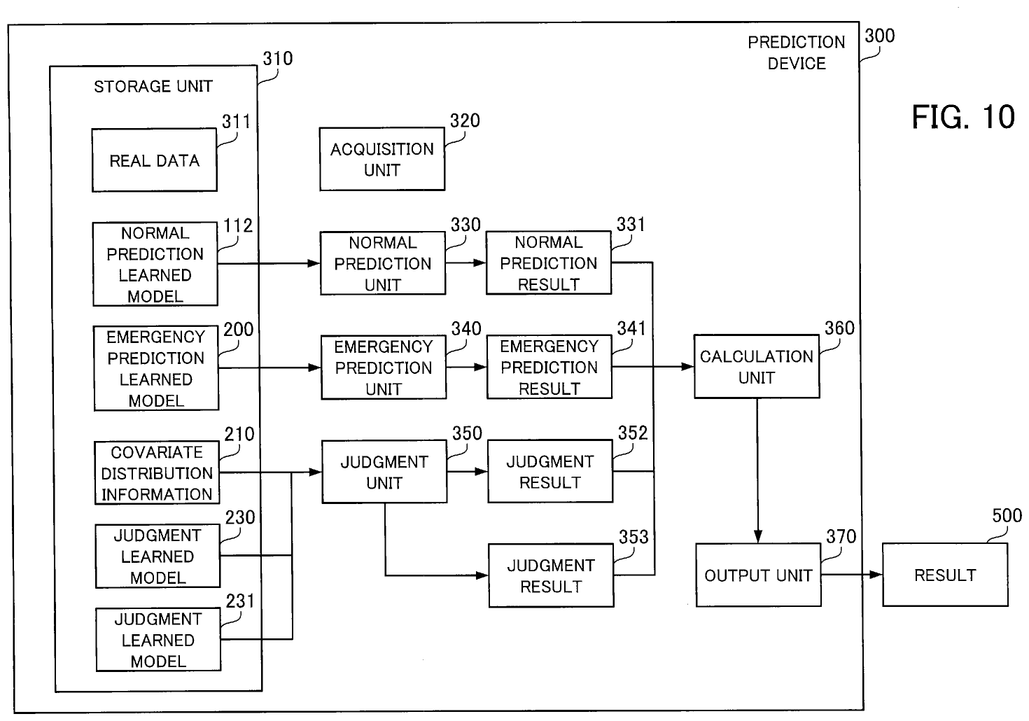

FIG. 10 is a block diagram showing functions of a prediction device in the second embodiment. The storage unit 310 may store the judgment learned models 230 and 231. The acquisition unit 320 acquires the judgment learned models 230 and 231 instead of the judgment learned model 220. For example, the acquisition unit 320 acquires the judgment learned models 230 and 231 from the storage unit 310. Alternatively, for example, the acquisition unit 320 acquires the judgment learned models 230 and 231 from the server 400.

The judgment unit 350 judges whether the real data 311 is data in normal times or data in emergency times by using the real data 311 and the judgment learned model 230. The result of the judgment is referred to as a judgment result 352. It is also possible for the judgment unit 350 to judge whether the real data 311 is data in normal times or data in emergency times by using the real data 311, the covariate distribution information 210 and the judgment learned model 230.

The judgment unit 350 judges whether the real data 311 is data in normal times or data in emergency times by using the real data 311 and the judgment learned model 231. The result of the judgment is referred to as a judgment result 353. It is also possible for the judgment unit 350 to judge whether the real data 311 is data in normal times or data in emergency times by using the real data 311, the covariate distribution information 210 and the judgment learned model 231.

The calculation unit 360 calculates the number of people at the first spot at the time indicated by the real data 311 by using the normal prediction result 331, the emergency prediction result 341 and the judgment results 352 and 353. For example, when the judgment results 352 and 353 indicate that the real data 311 is data in normal times, the calculation unit 360 calculates the result indicated by the normal prediction result 331 as the number of people at the first spot at the time indicated by the real data 311. Further, for example, when the judgment results 352 and 353 indicate that the real data 311 is data in emergency times, the calculation unit 360 calculates the result indicated by the emergency prediction result 341 as the number of people at the first spot at the time indicated by the real data 311. When the judgment result 352 and the judgment result 353 differ from each other, the calculation unit 360 judges that the probability that the real data 311 is data in normal times is “50%” and the probability that the real data 311 is data in emergency times is “50%”. The calculation unit 360 calculates the number of people at the first spot at the time indicated by the real data 311 by using the weighted average like the expression (2).

Here, as mentioned earlier, it is also possible for each judgment learned model 230, 231 to output the probability that the input information is data in normal times and the probability that the input information is data in emergency times. In cases where the judgment learned model 230 is capable of outputting the two probabilities, the judgment unit 350 judges the probability that the real data 311 is data in normal times and the probability that the real data 311 is data in emergency times, by using the real data 311 and the judgment learned model 230. Then, the result of the judgment is referred to as the judgment result 352. In cases where the judgment learned model 231 is capable of outputting the two probabilities, the judgment unit 350 judges the probability that the real data 311 is data in normal times and the probability that the real data 311 is data in emergency times, by using the real data 311 and the judgment learned model 231. Then, the result of the judgment is referred to as the judgment result 353.

In cases where each judgment learned model 230, 231 is capable of outputting the two probabilities, the calculation unit 360 calculates the average of the probabilities of being data in normal times indicated by the judgment results 352 and 353. For example, when the average value is “80%”, the calculation unit 360 determines that the probability of being data in emergency times is “20% (=100−80)”. It is also possible for the calculation unit 360 to calculate the average of the probabilities of being data in emergency times indicated by the judgment results 352 and 353 and thereafter calculate the probability of being data in normal times (e.g., 80%) by using the average value (e.g., 20%). The calculation unit 360 calculates the number of people at the first spot at the time indicated by the real data 311 as shown in the expression (2).

It is also possible for the calculation unit 360 to calculate the probability that the real data 311 is data in normal times and the probability that the real data 311 is data in emergency times, by using the real data 311, the covariate distribution information 210 and the judgment learned models 230 and 231. Specifically, the calculation unit 360 calculates the probability that the real data 311 is data in normal times (e.g., 60%) and the probability that the real data 311 is data in emergency times (e.g., 40%) by using the real data 311 and the judgment learned model 230. The calculation unit 360 calculates the probability that the real data 311 is data in normal times (e.g., 60%) and the probability that the real data 311 is data in emergency times (e.g., 40%) by using the real data 311 and the judgment learned model 231. The calculation unit 360 calculates the probability that the real data 311 is data in normal times (e.g., 60%) by using the normal-time covariate distribution included in the covariate distribution information 210 and the real data 311. The calculation unit 360 calculates the probability that the real data 311 is data in emergency times (e.g., 40%) by using the emergency-time covariate distribution included in the covariate distribution information 210 and the real data 311. The calculation unit 360 calculates the probability that the real data 311 is data in normal times by using coefficients. For example, the calculation unit 360 calculates the probability that the real data 311 is data in normal times by using expression (3). Here, a coefficient for the output result of the judgment learned model 230 is assumed to be 0.4. A coefficient for the output result of the judgment learned model 231 is assumed to be 0.2. A coefficient for the result when using the normal-time covariate distribution is assumed to be 0.4.

$$0.6 = 0.6 \times 0.4 + 0.6 + 0.2 \times 0.6 + 0.4 \qquad ( 3 )$$

The calculation unit 360 calculates the probability of being data in normal times (e.g., 60%) by multiplying the result by 100. When the probability is “60%”, the calculation unit 360 determines that the probability of being data in emergency times is “40% (=100−60)”. The calculation unit 360 calculates the number of people at the first spot at the time indicated by the real data 311 by using the weighted average like the expression (2). The above description was given of the case where the probability of being data in emergency times is calculated after the probability of being data in normal times is calculated. However, it is also possible for the calculation unit 360 to calculate the probability that the real data 311 is data in normal times after calculating the probability of being data in emergency times according to a similar method.

Next, a concrete example will be described below.

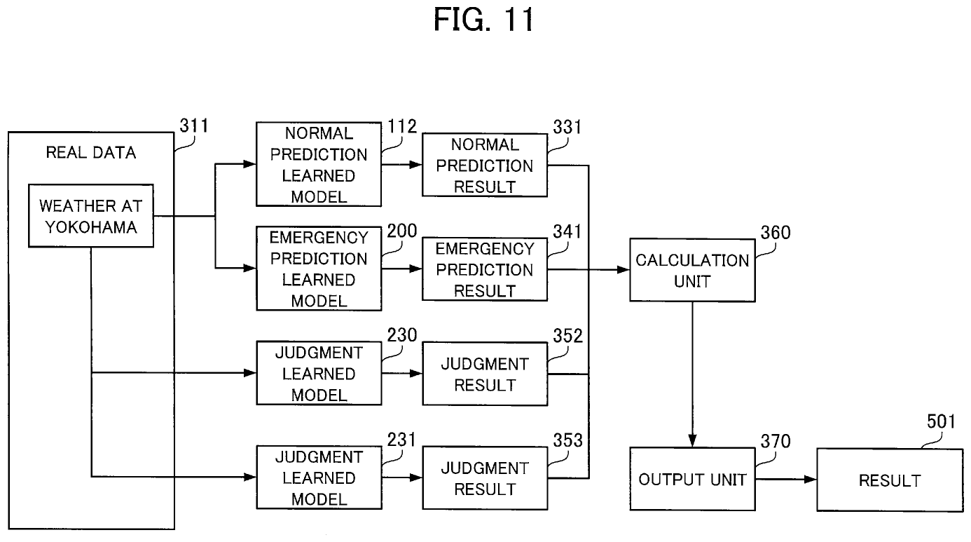

FIG. 11 is a diagram showing a concrete example of the second embodiment. The real data 311 includes information regarding the weather at Yokohama at 7 o'clock.

The normal prediction unit 330 predicts the number of people at Yokohama at 7 o'clock by using the information regarding the weather at Yokohama at 7 o'clock and the normal prediction learned model 112. The result of the prediction is the normal prediction result 331.

The emergency prediction unit 340 predicts the number of people at Yokohama at 7 o'clock by using the information regarding the weather at Yokohama at 7 o'clock and the emergency prediction learned model 200. The result of the prediction is the emergency prediction result 341.

Here, the judgment learned model 230 is assumed to be a learned model that outputs information indicating whether input information is data in normal times or data in emergency times when information regarding the weather at Osaka at a certain time is inputted thereto. The judgment learned model 231 is assumed to be a learned model that outputs information indicating whether input information is data in normal times or data in emergency times when information regarding the weather at Nagoya at a certain time is inputted thereto.

The judgment unit 350 judges whether the information regarding the weather at Yokohama at 7 o'clock is data in normal times or data in emergency times by using the information regarding the weather at Yokohama at 7 o'clock and the judgment learned model 230. The result of the judgment is the judgment result 352.

The judgment unit 350 judges whether the information regarding the weather at Yokohama at 7 o'clock is data in normal times or data in emergency times by using the information regarding the weather at Yokohama at 7 o'clock and the judgment learned model 231. The result of the judgment is the judgment result 353.

The calculation unit 360 calculates the number of people at Yokohama at 7 o'clock by using the normal prediction result 331, the emergency prediction result 341, and the judgment results 352 and 353.

The output unit 370 outputs the result 501 of the calculation.

As described above, the judgment learned model 230 is a learned model that outputs information indicating whether the information regarding the weather at Osaka at a certain time is data in normal times or data in emergency times. Even so, the judgment unit 350 judges whether the information regarding the weather at Yokohama at 7 o'clock is data in normal times or data in emergency times by using the judgment learned model 230. The reason for making the judgment by using the judgment learned model 230 is as follows. The difference between the judgment learned model 220 and the judgment learned model 230 is the spot indicated by the learning data at the time of the learning. The contents of the judgment do not change even when the spot is different. For example, when information indicating that the weather at Yokohama is fine weather is inputted to the judgment learned model 220, the judgment learned model 220 outputs information indicating that the real data 311 is data in normal times. When information indicating that the weather at Osaka is fine weather is inputted to the judgment learned model 230, the judgment learned model 230 outputs information indicating that the real data 311 is data in normal times. As above, the contents of the judgment do not change. Thus, it can be considered that there is no problem even if the judgment learned model 230 is used instead of the judgment learned model 220. Therefore, the judgment unit 350 uses the judgment learned model 230. The reason why the judgment unit 350 uses the judgment learned model 231 is also the same.

As above, the judgment unit 350 is capable of judging the information regarding the weather at Yokohama without using the judgment learned model 220 as in the first embodiment.

In the second embodiment, the description has been given of the case where two judgment learned models are used. It is permissible even if one judgment learned model is used.

Features in the embodiments described above can be appropriately combined with each other.

### DESCRIPTION OF REFERENCE CHARACTERS

10: new learning data, 11: emergency prediction model, 12: new learning data, 21: new learning data, 22: new learning data, 100: learning device, 101: processor, 102: volatile storage device, 103: nonvolatile storage device, 110: storage unit, 111: first learning data, 112: normal prediction learned model, 113: true value information, 113_1: normal-time true value, 113_2: emergency-time true value, 114: second learning data, 120: acquisition unit, 130: learning generation unit, 140: output unit, 200: emergency prediction learned model, 210: covariate distribution information, 220: judgment learned model, 230: judgment learned model, 231: judgment learned model, 300: prediction device, 310: storage unit, 311: real data, 320: acquisition unit, 330: normal prediction unit, 331: normal prediction result, 340: emergency prediction unit, 341: emergency prediction result, 350: judgment unit, 351: judgment result, 352: judgment result, 353: judgment result, 360: calculation unit, 370: output unit, 400: server, 500: result, 501: result

What is claimed is:

1. A learning device comprising:
acquiring circuitry to acquire first learning data as information indicating at least one of weather at a first spot at a plurality of times and congestion information as information regarding congestion, a normal prediction learned model that outputs a number of people in normal times at the first spot at a certain time when first information indicating at least one of the congestion information and the weather at the first spot at the certain time is inputted thereto, and true value information including true values indicating the numbers of people in normal times at the first spot at a plurality of times and true values indicating the numbers of people in emergency times at the first spot at a plurality of times;
learning generation circuitry to generate an emergency prediction learned model that outputs the number of people in emergency times at the first spot at the certain time when the first information is inputted thereto by using the first learning data, the normal prediction learned model and the true value information; and
outputting circuitry to output the normal prediction learned model and the emergency prediction learned model.

2. The learning device according to claim 1, wherein in a case where the first spot is a station, the first learning data includes operation information on trains traveling through the station.

3. The learning device according to claim 1, wherein the learning generation circuitry
calculates the numbers of people at the first spot at a plurality of times as a plurality of predictive values by using the first learning data, or learning information including the first learning data, and the normal prediction learned model,
calculates a plurality of errors based on the true values indicating the numbers of people in normal times at the first spot at the plurality of times and the plurality of predictive values,
calculates a proportion of each of the plurality of errors in all the errors,
increases the number of pieces of data in emergency times included in the first learning data or the learning information depending on the proportion,
generates the first learning data or the learning information, in which the number of pieces of data in emergency times has been increased, as new learning data, and
generates the emergency prediction learned model by using the true values indicating the numbers of people in emergency times at the first spot at the plurality of times and the new learning data.

4. The learning device according to claim 3, wherein
the learning generation circuitry
calculates the number of people at the first spot at a certain time by using data in normal times included in the first learning data or the learning information and the normal prediction learned model,
calculates an error between the true value indicating the number of people in normal times at the first spot and the calculated number of people, and
relearns the normal prediction learned model when the calculated error is included in a predetermined range, and
the outputting circuitry outputs the relearned normal prediction learned model and the emergency prediction learned model.

5. The learning device according to claim 1, wherein the learning generation circuitry
identifies data in emergency times out of the first learning data by using the first learning data, the normal prediction learned model, and the true values indicating the numbers of people in normal times at the first spot at the plurality of times,
generates the identified data in emergency times as new learning data, and
generates the emergency prediction learned model by using the new learning data and the true values indicating the numbers of people in emergency times at the first spot at the plurality of times.

6. The learning device according to claim 1, wherein the learning generation circuitry generates a first judgment learned model that outputs information indicating whether the first information is data in normal times or data in emergency times when the first information is inputted thereto or a first judgment learned model that outputs a probability that the first information is data in normal times and a probability that the first information is data in emergency times when the first information is inputted thereto by using the first learning data.

7. The learning device according to claim 1, wherein
In a case where the first spot is a station, the first learning data includes operation information on trains traveling through the station, and
the learning generation circuitry generates a first judgment learned model that outputs information indicating whether information including the first information and the operation information is data in normal times or data in emergency times when the first information and the operation information are inputted thereto or a first judgment learned model that outputs a probability that the information including the first information and the operation information is data in normal times and a probability that the information including the first information and the operation information is data in emergency times when the first information and the operation information are inputted thereto by using the first learning data.

8. The learning device according to claim 1, wherein
the acquiring circuitry acquires second learning data as information indicating at least one of the congestion information and the weather at a spot other than the first spot at a plurality of times, and
the learning generation circuitry generates a second judgment learned model that outputs information indicating whether second information indicating at least one of the congestion information and the weather at a spot other than the first spot at a certain time is data in normal times or data in emergency times when the second information is inputted thereto or a second judgment learned model that outputs a probability that the second information is data in normal times and a probability that the second information is data in emergency times when the second information is inputted thereto by using the second learning data.

9. A prediction device comprising:
acquiring circuitry to acquire real data as information indicating at least one of weather at a first spot at a certain time and congestion information as information regarding congestion, a normal prediction learned model, an emergency prediction learned model, and a first judgment learned model;
normal predicting circuitry to predict a number of people in normal times at the first spot at the certain time by using the real data and the normal prediction learned model;
emergency predicting circuitry to predict the number of people in emergency times at the first spot at the certain time by using the real data and the emergency prediction learned model;
judging circuitry to judge whether the real data is data in normal times or data in emergency times by using the real data and the first judgment learned model;
calculating circuitry to calculate the number of people at the first spot at the certain time by using a normal prediction result indicating the number of people in normal times, an emergency prediction result indicating the number of people in emergency times, and a judgment result as a result of the judgment; and
outputting circuitry to output a result of the calculation.

10. The prediction device according to claim 9, wherein
the acquiring circuitry acquires covariate distribution information including a normal-time covariate distribution and an emergency-time covariate distribution, and
the judging circuitry judges whether the real data is data in normal times or data in emergency times by using the real data, the covariate distribution information and the first judgment learned model.

11. The prediction device according to claim 9, wherein the judging circuitry judges a probability that the real data is data in normal times and a probability that the real data is data in emergency times by using the real data and the first judgment learned model.

12. The prediction device according to claim 11, wherein
the acquiring circuitry acquires covariate distribution information including a normal-time covariate distribution and an emergency-time covariate distribution, and
the judging circuitry judges the probability that the real data is data in normal times and the probability that the real data is data in emergency times by using the real data, the covariate distribution information and the first judgment learned model.

13. The prediction device according to claim 9, wherein in a case where the first spot is a station, the real data includes operation information on trains traveling through the station.

14. A prediction device comprising:
acquiring circuitry to acquire real data as information indicating at least one of weather at a first spot at a certain time and congestion information as information regarding congestion, a normal prediction learned model, an emergency prediction learned model, and a second judgment learned model that outputs information indicating whether input information is data in normal times or data in emergency times when information indicating at least one of the congestion information and the weather at a spot other than the first spot at the certain time is inputted thereto;
normal predicting circuitry to predict a number of people in normal times at the first spot at the certain time by using the real data and the normal prediction learned model;
emergency predicting circuitry to predict the number of people in emergency times at the first spot at the certain time by using the real data and the emergency prediction learned model;
judging circuitry to judge whether the real data is data in normal times or data in emergency times by using the real data and the second judgment learned model;
calculating circuitry to calculate the number of people at the first spot at the certain time by using a normal prediction result indicating the number of people in normal times, an emergency prediction result indicating the number of people in emergency times, and a judgment result as a result of the judgment; and
outputting circuitry to output a result of the calculation.

15. The prediction device according to claim 14, wherein
the acquiring circuitry acquires covariate distribution information including a normal-time covariate distribution and an emergency-time covariate distribution, and
the judging circuitry judges whether the real data is data in normal times or data in emergency times by using the real data, the covariate distribution information and the second judgment learned model.

16. The prediction device according to claim 14, wherein
the second judgment learned model is a learned model that outputs a probability that the input information is data in normal times and a probability that the input information is data in emergency times when the information indicating at least one of the congestion information and the weather at a spot other than the first spot at the certain time is inputted thereto, and
the judging circuitry judges a probability that the real data is data in normal times and a probability that the real data is data in emergency times by using the real data and the second judgment learned model.

17. The prediction device according to claim 14, wherein
the acquiring circuitry acquires covariate distribution information including a normal-time covariate distribution and an emergency-time covariate distribution, and
the judging circuitry judges a probability that the real data is data in normal times and a probability that the real data is data in emergency times by using the real data, the covariate distribution information and the second judgment learned model.

18. A prediction system comprising:
a server that stores real data as information indicating at least one of weather at a first spot at a certain time and congestion information as information regarding congestion, a normal prediction learned model, an emergency prediction learned model, and a first judgment learned model; and
a prediction device,
wherein the prediction device includes:
acquiring circuitry to acquire the real data, the normal prediction learned model, the emergency prediction learned model and the first judgment learned model from the server;
normal predicting circuitry to predict a number of people in normal times at the first spot at the certain time by using the real data and the normal prediction learned model;
emergency predicting circuitry to predict the number of people in emergency times at the first spot at the certain time by using the real data and the emergency prediction learned model;
judging circuitry to judge whether the real data is data in normal times or data in emergency times by using the real data and the first judgment learned model;
calculating circuitry to calculate the number of people at the first spot at the certain time by using a normal prediction result indicating the number of people in normal times, an emergency prediction result indicating the number of people in emergency times, and a judgment result as a result of the judgment; and
outputting circuitry to output a result of the calculation.

19. A prediction system comprising:
a server that stores real data as information indicating at least one of weather at a first spot at a certain time and congestion information as information regarding congestion, a normal prediction learned model, an emergency prediction learned model, and a second judgment learned model that outputs information indicating whether input information is data in normal times or data in emergency times when information indicating at least one of the congestion information and the weather at a spot other than the first spot at the certain time is inputted thereto; and
a prediction device,
wherein the prediction device includes:
acquiring circuitry to acquire the real data, the normal prediction learned model, the emergency prediction learned model and the second judgment learned model from the server;
normal predicting circuitry to predict a number of people in normal times at the first spot at the certain time by using the real data and the normal prediction learned model;
emergency predicting circuitry to predict the number of people in emergency times at the first spot at the certain time by using the real data and the emergency prediction learned model;
judging circuitry to judge whether the real data is data in normal times or data in emergency times by using the real data and the second judgment learned model;
calculating circuitry to calculate the number of people at the first spot at the certain time by using a normal prediction result indicating the number of people in normal times, an emergency prediction result indicating the number of people in emergency times, and a judgment result as a result of the judgment; and
outputting circuitry to output a result of the calculation.

20. A learning method performed by a learning device, the learning method comprising:
acquiring first learning data as information indicating at least one of weather at a first spot at a plurality of times and congestion information as information regarding congestion, a normal prediction learned model that outputs a number of people in normal times at the first spot at a certain time when first information indicating at least one of the congestion information and the weather at the first spot at the certain time is inputted thereto, and true value information including true values indicating the numbers of people in normal times at the first spot at a plurality of times and true values indicating the numbers of people in emergency times at the first spot at a plurality of times;
generating an emergency prediction learned model that outputs the number of people in emergency times at the first spot at the certain time when the first information is inputted thereto by using the first learning data, the normal prediction learned model and the true value information; and
outputting the normal prediction learned model and the emergency prediction learned model.

21. A prediction method performed by a prediction device, the prediction method comprising:
acquiring real data as information indicating at least one of weather at a first spot at a certain time and congestion information as information regarding congestion, a normal prediction learned model, an emergency prediction learned model, and a first judgment learned model;
predicting a number of people in normal times at the first spot at the certain time by using the real data and the normal prediction learned model, predicting the number of people in emergency times at the first spot at the certain time by using the real data and the emergency prediction learned model, and judging whether the real data is data in normal times or data in emergency times by using the real data and the first judgment learned model;
calculating the number of people at the first spot at the certain time by using a normal prediction result indicating the number of people in normal times, an emergency prediction result indicating the number of people in emergency times, and a judgment result as a result of the judgment; and
outputting a result of the calculation.

22. A prediction method performed by a prediction device, the prediction method comprising:
acquiring real data as information indicating at least one of weather at a first spot at a certain time and congestion information as information regarding congestion, a normal prediction learned model, an emergency prediction learned model, and a second judgment learned model that outputs information indicating whether input information is data in normal times or data in emergency times when information indicating at least one of the congestion information and the weather at a spot other than the first spot at the certain time is inputted thereto;
predicting a number of people in normal times at the first spot at the certain time by using the real data and the normal prediction learned model, predicting the number of people in emergency times at the first spot at the certain time by using the real data and the emergency prediction learned model, and judging whether the real data is data in normal times or data in emergency times by using the real data and the second judgment learned model;
calculating the number of people at the first spot at the certain time by using a normal prediction result indicating the number of people in normal times, an emergency prediction result indicating the number of people in emergency times, and a judgment result as a result of the judgment; and
outputting a result of the calculation.

23. A prediction device comprising:
a processor to execute a program; and
a memory to store the program which, when executed by the processor, performs processes of,
acquiring real data as information indicating at least one of weather at a first spot at a certain time and congestion information as information regarding congestion, a normal prediction learned model, an emergency prediction learned model, and a first judgment learned model,
predicting a number of people in normal times at the first spot at the certain time by using the real data and the normal prediction learned model, predicting the number of people in emergency times at the first spot at the certain time by using the real data and the emergency prediction learned model, and judging whether the real data is data in normal times or data in emergency times by using the real data and the first judgment learned model,
calculating the number of people at the first spot at the certain time by using a normal prediction result indicating the number of people in normal times, an emergency prediction result indicating the number of people in emergency times, and a judgment result as a result of the judgment, and
outputting a result of the calculation.

24. A prediction device comprising:
a processor to execute a program; and
a memory to store the program which, when executed by the processor, performs processes of,
acquiring real data as information indicating at least one of weather at a first spot at a certain time and congestion information as information regarding congestion, a normal prediction learned model, an emergency prediction learned model, and a second judgment learned model that outputs information indicating whether input information is data in normal times or data in emergency times when information indicating at least one of the congestion information and the weather at a spot other than the first spot at the certain time is inputted thereto,
predicting a number of people in normal times at the first spot at the certain time by using the real data and the normal prediction learned model, predicting the number of people in emergency times at the first spot at the certain time by using the real data and the emergency prediction learned model, and judging whether the real data is data in normal times or data in emergency times by using the real data and the second judgment learned model,
calculating the number of people at the first spot at the certain time by using a normal prediction result indicating the number of people in normal times, an emergency prediction result indicating the number of people in emergency times, and a judgment result as a result of the judgment, and
outputting a result of the calculation.
